(19) United States
(12) Patent Application Publication
(10) Pub. No.: US 2024/0187484 A1
(43) Pub. Date: Jun. 6, 2024

(54) Support and Preventative Maintenance of Internet of Things Devices

(71) Applicant: Helios Technologies, Inc., Sarasota, FL (US)

(72) Inventors: James J. Grogan, Waunakee, WI (US); Benjamin Arciszewski, Madison, WI (US); Wei Zhou, Verona, WI (US)

(73) Assignee: Helios Technologies, Inc., Sarasota, FL (US)

(21) Appl. No.: 18/520,653

(22) Filed: Nov. 28, 2023

Related U.S. Application Data
(60) Provisional application No. 63/429,799, filed on Dec. 2, 2022.

(51) Int. Cl. H04L 67/12; H04L 41/16; H04L 41/5074

(52) U.S. Cl. CPC H04L 67/12; H04L 41/16; H04L 41/5074; G16Y 40/40

(57) ABSTRACT

An artificial intelligence engine establishes a remote session with an IoT device through a proxy app running on a user's smartphone, and operates to identify the conditions present on the device and automatically reconfigure and repair the device. If a solution cannot be determined automatically, the remote session is transferred to a human support agent to diagnose the problem, develop a first solution and remotely adjust the device to apply the first solution. Proxy apps on many second smartphones automatically query similar IoT devices near the second smartphones. Wireless connections are established with the devices and a determination is made as to whether conditions similar to an earlier set of conditions exist at each IoT device, to thereby identify potentially problematic devices. The first solution is then applied to the devices identified as being potentially problematic.

### CROSS REFERENCES TO RELATED APPLICATIONS

This application claims the benefit of priority of U.S. Provisional App. No. 63/429,799, filed Dec. 2, 2022, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to technical support and maintenance of internet of things (IoT) devices.

In the Internet of Things (IOT) everyday objects and devices are provided with networking hardware and often sensors. These IoT devices may be for individual consumers, commercial applicability, and/or industrial applicability. Consumer IoT devices may include vehicles, home automation, wearables, and other devices and applications. Commercial applications of IoT devices may include medical devices, building automation, industrial applications, manufacturing, agricultural machinery, and others.

The IoT devices may measure particular attributes of an object or situation, generating data. The data may then be passed, for example, through a network to a particular receiving point for analysis and reporting to a user. IoT devices may be relatively low-cost and may be relatively abundant. IoT devices may have limited computational and network capabilities. IoT devices may therefore be reliant on a secondary device for configuration and connection.

U.S. Pat. No. 10,848,567 discloses an approach to providing assistance to end-users in the connectivity of IoT devices and troubleshooting issues in the field. Where an on-site support technician is not available due to the low cost, high scale nature of modern IoT and connected devices, remote technicians can make a connection to the user and a nearby IoT device through the user's smartphone. The remote technician can address the complex issues that might arise with connected devices including establishing a connection to the internet, diagnosing sensor issues, determining if product returns are required, making remote firmware updates and many other issues.

The manufacturer's support services develop extensive experience in dealing with real world problems encountered by users. What is needed is a way to provide automation to more effectively and expeditiously resolve the issues that IoT device users encounter, offering a more satisfactory user experience at reasonable cost.

### SUMMARY OF THE INVENTION

An artificial intelligence engine establishes a remote session with an IoT device through a proxy app running on a user's smartphone, and by using BLE characteristics and a dynamic remote rules engine in an unattended support session of an IoT device, proxied by a mobile device, operates to identify the conditions present on the device and automatically reconfigure and repair the device, or if that is not possible, transfers the user session to a human support agent to diagnose and remotely adjust the device, in either case applying a first solution. A multiplicity of proxy apps running on a multiplicity of smartphones automatically query similar IoT devices when the users and their smartphones come into proximity with the similar devices. Wireless connections are established with the devices and a determination is made as to whether conditions similar to the first set of conditions exist at each IoT device, to thereby identify potentially problematic devices. The first solution is then applied to the devices identified as being potentially problematic.

It is an object of the invention to provide an artificial intelligence (AI) engine which works directly with IoT device users to facilitate resolution of issues without human intervention.

It is a further object of the invention to provide an AI engine which can determine that an issue is beyond its capacity to resolve, and which can hand off unresolved issues with IoT devices to a human support agent.

It is an additional object of the invention to provide a system which identifies IoT devices which are potentially problematic, and which applies a solution.

It is yet another object of the present invention to provide a method for offering ongoing maintenance to IoT devices which shares the benefits of prior experience in addressing device problems for later device needs.

Further objects, features and advantages of the invention will be apparent from the following detailed description when taken in conjunction with the accompanying drawings.

### BRIEF DESCRIPTION OF THE DRAWINGS

FIG. 1 is a schematic illustration of an AI assisted IoT device support system of this invention.

FIG. 2 is a schematic illustration of a preventive maintenance system for multiple similar IoT devices.

### DESCRIPTION OF THE PREFERRED EMBODIMENTS

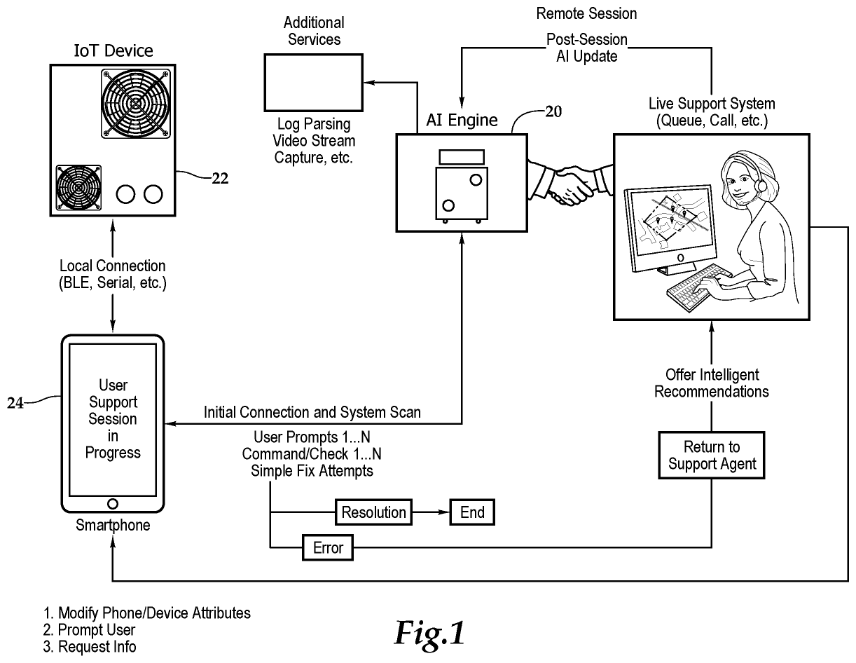

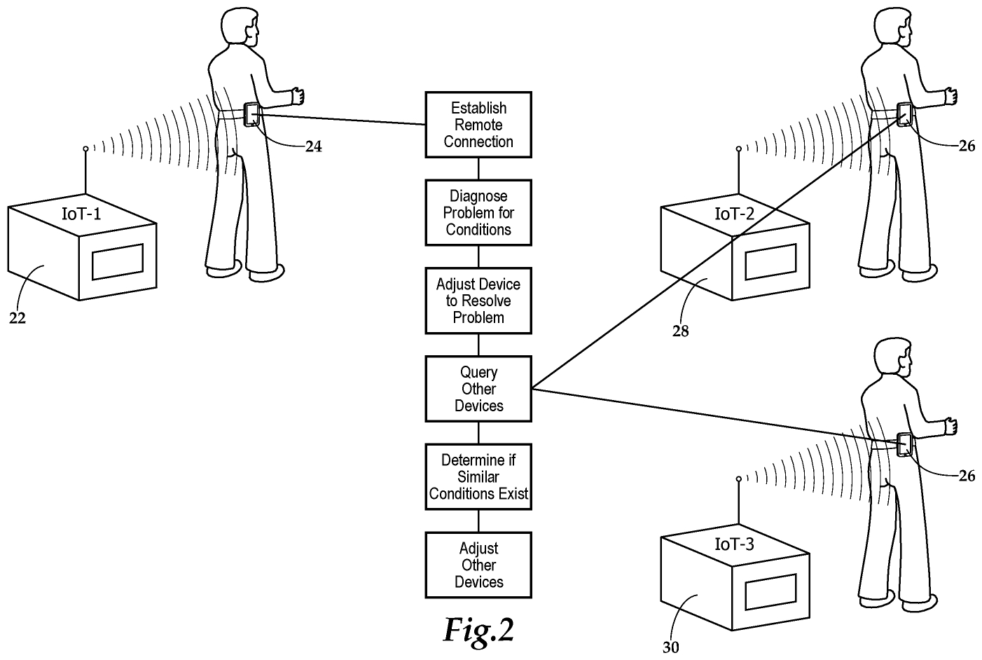

Referring more particularly to FIGS. 1-2, wherein like numbers refer to similar parts, An automated support engine 20 uses dynamic rules engine artificial intelligence (AI) to support a remote internet of things (IOT) device 22 in proximity to a user operating a smartphone 24 having a proxy app installed thereon, such as is disclosed in U.S. Pat. No. 10,848,567, the disclosure of which is incorporated by reference herein. The support engine 20 may be implemented as part of a computer having processors, data storage, and connections to the internet, cellular networks or other methods of establishing a wireless connection with a proxy app on a smartphone.

The smartphone is equipped with multiple mechanisms for transmitting data over a network, for example, a Bluetooth hardware component, a mobile internet component, and/or a wireless internet component. By smartphone is meant a portable device which is capable of wirelessly connecting to cellular voice networks and also to the wireless communication system of an IoT device, and which has the capability to display graphics and has the ability to download and run an application (app). A proxy is defined as a device that is an intermediary between two devices that serves to transmit communications between two devices that do not communicate directly with one another. A proxy app is software that enables a device to serve as a proxy.

The AI support engine 20 establishes a peer-to-peer connection between the smartphone proxy app and the remote AI engine, such as with WebRTC over the internet. The proxy app scans the IoT device and establishes a wireless connection between the smartphone and the IoT device. By issuing instructions from the AI engine to the smartphone proxy app, the AI can solicit or receive data from the IoT device and thereby adjust, configure, or diagnose the status of the IoT device based on previously configured rules for that particular IoT device type. Common problems addressed may be those related to connectivity, the wireless signal, and the environment's effect on electronics. The conditions of the IoT device can be determined, such as the location of the device, its age, the type of device, the physical environment including temperature and environmental variables, the presence of dirt, the noise level, humidity, vibration levels and other material of electrical conditions. The interactive AI can prompt the user to do tasks and request input from the user to supplement the automated support of the product in the case of physical issues. The user tasks might be physically interacting with the device, such as by unplugging it or resetting it.

Through the proxy app the AI engine can make simple fix attempts, for example by adjusting IoT device settings and then assessing whether the problem has been resolved. Multiple attempts may be undertaken under the direction of the AI engine until the problem is successfully resolved. For example, the AI engine may send commands to the IoT to undertake the processes needed to adjust, configure, or diagnose the status of the IoT device, i.e., updating firmware, updating device configuration, streaming device logs, assessing debug information, or configuring the device to connect to the internet.

However, if the AI cannot solve the problem with the IoT device, the AI engine facilitates the transfer of the remote session to a human agent to diagnose and fix the issue manually. The AI supplies a report with recommendations to assist the agent in repairing the issue that the AI could not fix. This report may include a listing of conditions and the fix attempts unsuccessfully attempted.

The AI can be further leveraged to assist the human agent with diagnostic tasks after the session is handed off to the human agent. These tasks might include groups of diagnostics tasks, log analyses, sequences of commands, parsing responses, and working through third party services that might assist with the diagnosis of the problem.

When the user verifies that the fix is complete, the solution is stored electronically along with the conditions that were associated with the serviced device. After the problem is solved, the connection between the AI and the smartphone proxy app is disconnected.

When the human agent is able to solve the problem, a new rule can be added to train the engine for use by the AI in future support sessions associated with the malfunction.

In FIG. 2 is illustrated a system for applying the solutions developed in servicing a first IoT device to service and provide preventative maintenance for other devices experiencing similar conditions. After establishing a remote connection with a first IoT device 22 through a proxy app running on a first user's smartphone 24, diagnosing a problem on the first IoT device and determining a set of conditions associated with the problem, and remotely adjusting the first IoT device to resolve the problem utilizing a first solution as discussed above, the solution and the conditions of the IoT device are stored for access by the AI engine. The AI engine receives many problems and solutions from multiple users throughout the service area who report problems by initiating a support session through the proxy app. Resolving problems identified by users is of great value, but preventing problems from reaching a level which significantly impairs device performance takes service to a more substantial level.

Throughout the geographic service area handled by the support system employing the AI engine, there may be hundreds, thousands, or millions of devices, all subject to degradation due to internal and external conditions. Perhaps an industrial IoT device is experiencing an increase in particulate levels within its lubrication system which has been associated in the past with a malfunction. The treatment of a previously malfunctioning similar IoT device has given the AI engine data on the particulate levels that cause malfunction. Using the proxy app installed in second users' smartphones 26, the support system queries a second IoT device 28, a third IoT device 30 and potentially thousands of others. There need not be a scheduled time for this query, but it may be carried out when the user next comes in proximity to a supported IoT device, at which time the proxy app installed on the user's smartphone establishes a wireless connection thereby detecting the presence of the device and then automatically querying it to detect the conditions of the device. Through the proxy app, the AI engine determines whether the conditions detected in the second or third IoT device are similar to the conditions related to the problem previously resolved by the AI engine. By this ongoing querying of IoT devices it is possible to identify those devices which are potentially problematic, that is, which are prone or disposed to suffering a problem which the AI engine has previously encountered and resolved. The AI engine then, through the proxy app, remotely adjusts each of the potentially problematic devices to implement the solution previously identified for that type of device under similar conditions.

The AI Engine can thus utilize thousands of interactions with similar IoT devices to preventatively maintain many more devices, improving the overall performance of that device type. For example, millions of users, with millions of smartphones with installed proxy apps may pass in the vicinity of an IoT device of a particular type each day. The AI Engine can assess millions of devices and determine, for example, that ten thousand are experiencing a similar error. From the experience of successful fixes, a likely solution is identified by the AI engine and peremptorily implemented on the devices experiencing the error. In cases where the solution cannot be implemented entirely through the proxy app, i.e. solutions requiring replacement or physical adjustment of hardware, the user or other person responsible for the device may be contacted through an automated phone call, an email, or a text message with a notification inviting the owner or responsible person to initiate physical adjustment of the device, such as by calling a service technician or installing a replacement part. The manufacturer, dealer or service center for the problematic device may also receive some type of electronic notification, or even a printed notice received through the mail. Once the dealer or physical service provider is aware that its customer has a problem, it can contact the customer through any desired communication channel and offer a service call in advance of device failure.

More broadly, when enhancements are added to software which will benefit all devices, the system can instruct the proxy app to install the upgraded software the next time it comes in proximity to the IoT device.

It is understood that the invention is not limited to the particular construction and arrangement of parts herein illustrated and described but embraces all such modified forms thereof as come within the scope of the following claims.

I claim:

1. A process for supporting an Internet of Things (IOT) device comprising:
establishing a remote connection with the IoT device through a proxy app running on a user's smartphone;
establishing a peer-to-peer connection between the smartphone proxy app and a remote AI engine;
causing the proxy app to scan the IoT device and establish a wireless connection between the smartphone and the IoT device;
issuing instructions from the remote AI engine to the smartphone proxy app to solicit or receive data from the IoT device; and
based on the solicited or received data from the IoT device, adjusting, configuring, or diagnosing the status of the IoT device under the control of the AI engine based on previously configured rules for that particular IoT device type.

2. The process of claim 1 further comprising establishing a connection over the user's smartphone with a human remote support agent if the AI engine is unable to resolve a problem, for diagnosis and repair of the problem.

3. The process of claim 2 further comprising generating a recommendations report with the AI engine and providing the report to the human remote support agent to assist the human remote support agent in repairing the problem that the AI engine was unable to resolve.

4. The process of claim 3, wherein the AI engine assists the human remote support agent by providing a report including groups of diagnostics tasks, log analyses, sequences of commands, parsing responses, and working through third party services that might assist with the diagnosis of the problem.

5. A process for supporting Internet of Things (IOT) devices comprising:
establishing a remote connection with a first IoT device experiencing a first problem through a proxy app running on a user's smartphone;
establishing a peer-to-peer connection between a smartphone proxy app and a remote AI engine;
causing the proxy app to scan the first IoT device and to establish a wireless connection between the smartphone and the first IoT device;
issuing instructions from the remote AI engine to the smartphone proxy app to solicit or receive data from the first IoT device, thus determining first problem characteristics of the first IoT device; and
based on the solicited or received data from the first IoT device, adjusting or configuring the status of the first IoT device under the control of the AI engine to address and resolve the first problem;
causing proxy apps on a multiplicity of smartphones to interrogate second IoT devices to identify second IoT devices having the first problem characteristics; and
adjusting or configuring the second IoT devices in the same manner as said adjusting or configuring of the first IoT device to anticipate and avoid the first problem occurring on the second IoT devices.

6. The process of claim 5 wherein the step of adjusting or configuring the second IoT device is carried out entirely over one of the proxy apps.

7. The process of claim 5 wherein the step of adjusting or configuring the second IoT devices comprises sending a notification to the persons responsible for the second IoT devices suggesting a physical adjustment of the second IoT devices.

8. The process of claim 5 wherein the determination of whether conditions similar to the first set of conditions exist at each of said plurality of second IoT devices include at least one condition selected from the group consisting of
location;
age;
type of device;
device components;
physical environment;
temperature;
environmental variables;
presence of dirt;
noise level;
humidity; and
vibration levels.

9. A process for supporting Internet of Things (IOT) devices, comprising:
establishing a remote connection with a first IoT device through a proxy app running on a first user's smartphone;
diagnosing a problem on the first IoT device and a first set of conditions associated with the problem;
remotely adjusting the first IoT device to resolve the problem utilizing a first solution;
utilizing a plurality of proxy apps running on a plurality of second users' smartphones to automatically query a plurality of second IoT devices when each of said plurality of second IoT devices comes close enough to said second user's smartphone to establish a wireless connection, to determine whether conditions similar to the first set of conditions exist at each of said plurality of second IoT devices and thereby identify potentially problematic devices; and
remotely adjusting each of the identified potentially problematic devices to implement the first solution thereon.

10. The process of claim 9 wherein the determination of whether conditions similar to the first set of conditions exist at each of said plurality of second IoT devices include at least one condition selected from the group consisting of
location;
age;
type of device;
device components;
physical environment;
temperature;
environmental variables;
presence of dirt;
noise level;
humidity; and
vibration levels.

11. The process of claim 9 wherein the step of remotely adjusting each of the identified potentially problematic devices to implement the first solution thereon is carried out entirely over the plurality of proxy apps.

12. The process of claim 9 wherein the step of remotely adjusting each of the identified potentially problematic devices to implement the first solution thereon comprises sending a notification to the persons responsible for the identified potentially problematic devices, the notification suggesting a physical adjustment pf said devices.
